(19) United States
(12) Patent Application Publication
(10) Pub. No.: US 2019/0136822 A1
(43) Pub. Date: May 9, 2019

(54) Pontoon System for Producing Useful Work

(71) Applicant: Robert L. Huebner, Santa Anna, TX (US)

(72) Inventor: Robert L. Huebner, Santa Anna, TX (US)

(21) Appl. No.: 16/237,160

(22) Filed: Dec. 31, 2018

Related U.S. Application Data
(63) Continuation-in-part of application No. 15/830,741, filed on Dec. 4, 2017, now abandoned.
Application No. 15/830,741 is a continuation-in-part of application No. 15/170,346, filed on Jun. 1, 2016, now abandoned.

(51) Int. Cl. F03B 7/00; B63B 35/44; B63B 35/38

(52) U.S. Cl. CPC F03B 7/003; B63B 35/44; B63B 35/38; F05B 2220/706; B63B 2035/4466; F05B 2260/4021; F05B 2260/403; F05B 2260/406; F05B 2240/932

(57) ABSTRACT

A water driven system for generating useful work has a floating support structure with a pair of spaced apart frame portions. A waterwheel is mounted between the two spaced apart frame portions in an upright manner. The waterwheel has a number of radially extending spokes for turning the waterwheel in response to a flow of water against the spokes when the floating support structure is mounted on a moving body of water. The waterwheel has outwardly extending axle shafts which are used to produce useful work as the wheel rotates.

### CROSS REFERENCE TO RELATED APPLICATIONS

The present application is a continuation-in-part of earlier filed Ser. No. 15/830,741, filed Dec. 4, 2017, entitled “Pontoon System For Producing Useful Work,” which in turn was a continuation-in-part of earlier filed Ser. No. 15/170,346, filed Jun. 1, 2016, entitled “Waterwheel For A Waterwheel Energy System” by the same inventor.

### BACKGROUND OF THE INVENTION

### 1. Field of the Invention

This invention relates generally to a new type of waterwheel used in a system for generating useful work. Use waterwheel may be located above a water reservoir with a water pump that delivers water from the reservoir to a discharge manifold which discharges water to the waterwheel at an elevated location, whereby the waterwheel powers a drive shaft that is connected to a load. The waterwheel may also be pontoon mounted or barge mounted on a body of moving water.

### 2. Description of the Prior Art

Due to the limitations of non-renewable energy sources, such as oil and coal, as well as the negative environmental effects of such energy sources, a need exists for the provision of alternative energy conversion and transfer systems. At the present time, there is increasing interest in renewable energy sources such as water based, solar, wind, wave and tidal power.

The tremendous growth in renewable energy over the past several years is well documented and the rate of growth continues to increase each year. With worldwide awareness of the negative environmental impacts of fossil fuels on our global environment, growth in the use of “green” or renewable energy appears to be constrained only by the ability to produce and deliver it at an economic price. Wind power, for example, has now entered the mainstream and has been the fastest growing segment of the energy industry over the last several years. Despite the current movement supporting renewable energy sources, many legislators and policy-makers are attempting to meet these demands through projects which relate solely to wind and solar power generation, and do not address renewable energy produced from water.

Water engines or water powered motors are thermodynamic engines for converting the pressure and weight of water into work and have been widely recognized as efficient source of power. Examples include water turbines for generating electricity, and waterwheels for operating belts and drive shafts to turn machinery. In the case of the waterwheel, water from, for example, a canal, reservoir or other natural waterway is typically used to fill a series of receptacles formed between a series of blades or vanes of a wheel-like structure. Imbalance resulting from the fill causes the wheel to rotate about its drive shaft, generating rotational force which may be coupled to other devices. The water is drained from the receptacles at a low point of rotation.

In one form of the present invention, a waterwheel is carried within a land based frame in an upright manner. The waterwheel has a plurality of water receiving elements in the form of troughs for turning the waterwheel in response to a discharge of water against the troughs.

In another form of the invention, the water wheel is barge or pontoon mounted on a river or stream or other moving body of water.

One particular object of the present invention is thus to provide a water wheel energy system that can be pontoon mounted or barge mounted on a body of moving water which can produce useful work.

Another object of the invention is to provide such a system which can be moved from one location to another.

Another object of the invention is to provide a waterwheel system with an improved waterwheel which more efficiently generates useful work than was possible with the known prior art devices.

Another object of the invention is to provide an inexpensive power generating system that can be easily set up along a river or stream to harness the natural flow of water for generating electric power on a relatively small scale.

Another object of the invention is to provide such a power generating system that can be operated without the need for highly trained staff and technicians to constantly maintain and support the associated equipment.

### SUMMARY OF THE INVENTION

The foregoing objects of the invention are met through the water driven system of the invention. In one form of the system of the invention, the water source whose power is harnessed to produce useful work is self-contained. The system has a number of operable components which are mounted on a frame which serves as an enclosure for components of the system. A waterwheel is carried within the frame in an upright manner and has a plurality of water receiving elements for turning the waterwheel in response to a discharge of water against the water receiving elements.

A water discharge manifold is associated with the frame having a discharge end disposed above the waterwheel in discharge alignment with the water receiving elements. A water collection reservoir is disposed below the waterwheel and integral with the frame for the collection of water which has been discharged from the manifold and received by the water receiving elements. A water pump or pumps are also provided for pumping water from the water collection reservoir through the water discharge manifold and out the discharge end thereof onto the water receiving elements.

The waterwheel has a pair of spaced apart wheel shaped side plates each having an exterior surface and an interior surface, and wherein each of the side plates has an axle shaft welded thereon at a right angle to the exterior surface at a central location on each of the side plates, the axle shafts each being mounted in a bearing structure on the frame for rotational movement with respect to the frame. The rotational movement of the axle shafts is used to provide useful work, e.g., to drive an electrical generator for generating electrical power.

The water receiving elements of the waterwheel can comprise a series of bucket shaped troughs which are welded between the two side plates. The water pumps which move water from the reservoir to the discharge manifold can be driven by an associated external power source selected from the group consisting of natural gas, solar power, propane, or the like.

Although the water driven system as has been described may be mounted on the frame and directly driven by one of the axle shafts of the waterwheel, in some versions of the invention, the frame will also have mounted thereon a hydraulic pump, driven by the waterwheel axle shaft, which is used to drive a hydraulic motor, the hydraulic motor, in turn, being used to drive the electrical generator for generating electrical power. The hydraulic pump and motor may be combined in one unit. The hydraulic motor/pump and electrical generator might even sit beside the frame, or at another more spaced-apart location. In some cases, it may be desirable to have a torque multiplier for the output shaft of the waterwheel to increase the rpm output. This might comprise a suitable gear, sprocket or pulley multiplier type system, such as a gear box located between a selected one of the axle shafts of the waterwheel and the hydraulic pump/motor for creating an increased rpm output for driving the hydraulic pump/motor.

The frame can be a portable skid winch allows the system to be moved from one location to another. In some cases, the frame will be located on land at a distant location from any natural water source.

In another version of the water driven system of the invention, the work generating components of the system are mounted on a floating structure, such as a pontoon or barge. This system is not “self-contained” as in the first described version of the invention. Rather, it depends upon the motive force of a moving body of water to provide the momentum for turning the waterwheel. The floating support structure has a pair of spaced apart frame portions. In the case of a pontoon, the spaced apart frame portions are floating outriggers of the pontoon. At least one waterwheel is mounted between the two spaced apart frame portions. The waterwheel which is used in this version of the system is unique in design in a number of critical respects from the waterwheel as has previously been described with respect to the self-contained system, as will be described more fully in the detailed description which follows. As before, the water wheel is mounted in an upright manner and has a plurality of spokes for turning the waterwheel in response to a flow of water against the spokes when the floating support structure is mounted on a moving body of water. Rotational movement of the axle shafts of the waterwheel is used to produce useful work.

In one preferred version of the pontoon system of the invention, the waterwheel has a series of radially arranged spokes made up by bent metal sheets. Each of the bent metal sheets has a relatively longer inner extent and a relatively shorter outer extent which is bent at an angle in the range from about 35 to 65° with respect to a line drawn perpendicular to the plane of the inner extent. The preferred angle will typically be in the range from about 40 to 50°, most preferably about 45°. Each of the spokes on the wheel can be formed, for example, by welding a longer piece of metal and a relatively shorter piece of metal along their entire length to the respective side plates of the waterwheel in the bent shape previously described. In a preferred form, the longer piece of metal makes up about two thirds of the total length of the spoke with the angled, shorter piece making up the remaining portion of the overall length. The inner, longer pieces of the bottom walls form a star shaped pattern approximately 72° apart with respect to the axis of the central shaft.

Also, in the final preferred form of the pontoon version of the invention, the spokes do not run all the way to the central shaft but rather are separated by a gap. The previously recited preferred spoke angle of 45° is also more “relaxed” than in previous versions of the waterwheel. Also, it will be apparent that mere are no “buckets” or “troughs” in this version of the device.

The pontoon version of the invention will not turn as fast as the land mounted version of the waterwheel and the entire wheel construction does not have to be as strong. Unlike the “buckets” of the land based version, the spokes of this wheel only serve to turn the wheel and do not act to hold or collect water. In fact, water can pass through the “gap” between the spokes and the central shaft. This version of the waterwheel might be constructed of a lightweight metal, such as aluminum, or even from a synthetic plastic or composite.

Because no parts extend beyond the radius of the wheel or otherwise beneath the pontoons, brush and other debris can freely pass under the pontoon boat.

Additional objects, features and advantages will be apparent from the written description which follows.

### BRIEF DESCRIPTION OF THE DRAWINGS

FIG. 1 is a simplified side view, partly schematic, of one version of the water driven system of the invention.

FIG. 2 is an isolated, exploded view of one version of the waterwheel which is used in the system of the invention.

FIG. 3 is an isolated, exploded view of another version of the waterwheel which is used in the system of the invention.

FIG. 4 is a simplified, side view, similar to FIG. 1, of the water driven system of the invention, showing the operation of the second version of the waterwheel.

FIG. 5 is a side view of another version of the waterwheel which is used in the practice of the invention with one of the side plates removed for ease of illustration.

FIG. 6 is a simplified top view of another version of the water driven system of the invention in which a pair of waterwheel are mounted between the outriggers of a floating pontoon.

FIG. 7 is a side view of the water driven system of FIG. 6.

FIG. 8 is a side view similar to FIG. 5 of a further evolution of the preferred waterwheel used with the pontoon version of the invention.

FIG. 9 is a side view, similar to FIG. 7, but showing the improved water wheel of FIG. 8.

### DETAILED DESCRIPTION OF THE INVENTION

The present invention provides a water driven system for generating useful work which meets the foregoing objectives. The invention described herein and the various features and advantageous details thereof are explained more fully with reference to the non-limiting examples which are illustrated in the accompanying drawing and detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

### The Self-Contained Version of the Invention

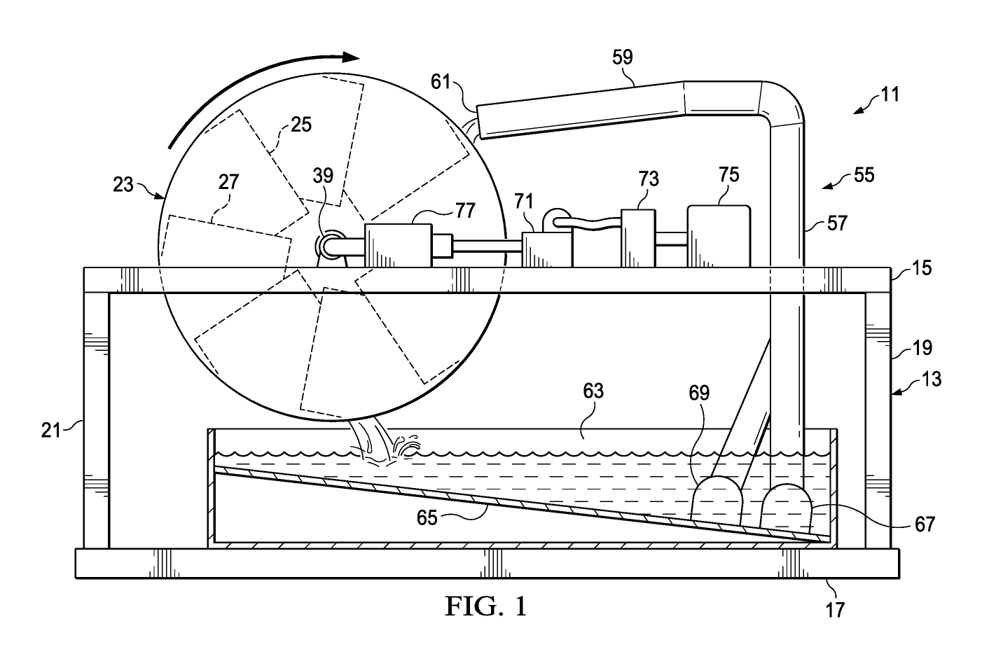

Turning first to FIG. 1, there is shown one version of a water driven system for creating useful work of the invention, designated generally as 11. There are some situations in which a water driven system of the type under consideration may most advantageously use its own self-contained water source. For example, when driven by natural water sources, the quantity of water available to drive a turbine can be uncertain at times, dependent upon the changing seasons and varying climatic conditions. During a rainy season the amount and flow of water present may be too great for the turbine. Conversely, in a time of less rain fall or little water, insufficient water flow may be present for efficient operation of the turbine. While man-made reservoirs and viaducts are often constructed to provide a constant water flow, it is well recognized that such installations often require expenditures of a great deal of funds, and further may not be feasible due to the geographic and climatic conditions associated with the desired location for the turbine. They further generally represent large-scale construction, and thus are impractical for water turbines of small or moderate capacity.

The system of the invention shown in FIGS. 1-4 represent such a self-contained water driven system for generating useful work. The system shown therein includes a frame 13 serving as an enclosure or mounting point for the principal components of the system. The frame could assume various forms, but most simply is a rectangular structure having top and bottom elements on either side (15 and 17 shown in FIG. 1) and connecting vertical side elements (19, 21 shown in FIG. 1). The frame could be formed of steel I-beams, or the like. The frame could be a permanently mounted structure, or could be in the nature of a portable skid which would allow the system to be moved from one location to another. Because of the size and weight of the waterwheel (to be described), it might be necessary to remove the waterwheel for separate transport in some cases. The frame might also be partly or totally buried in the ground to reduce the overall height of the assembly.

FIG. 1 shows a side view of one version of the waterwheel 23 which is used with the system of the invention. The waterwheel 23 is carried within the frame 13 in an upright manner and has a plurality of water receiving elements (shown in FIG. 1 as 25, 27, etc., in dotted lines) for turning the waterwheel in response to a discharge of water against the water receiving elements.

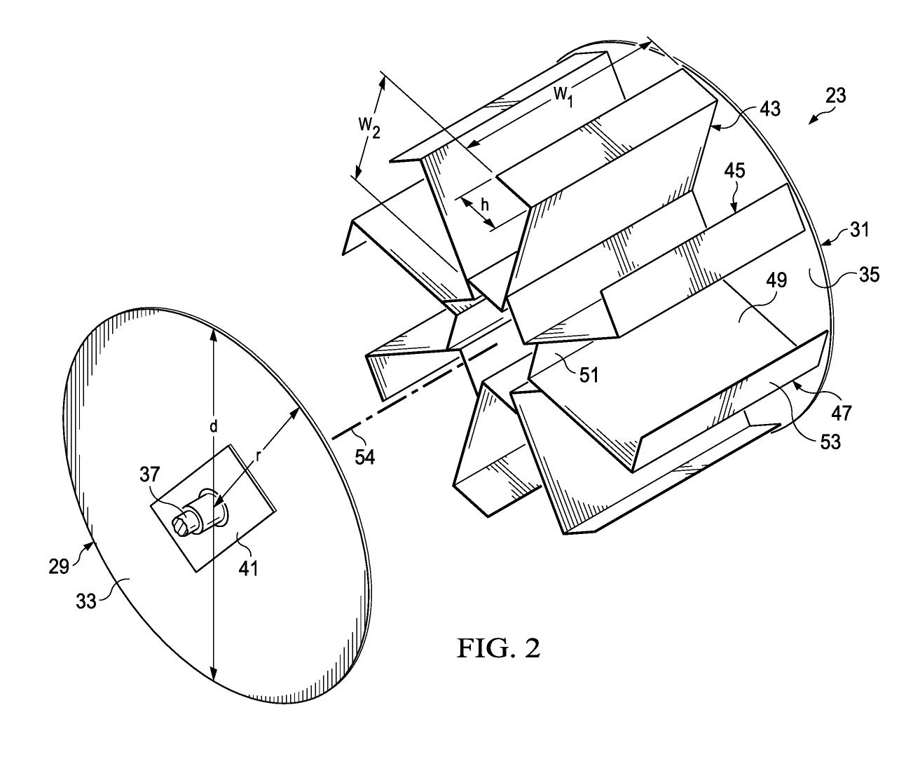

FIG. 2 shows a first version of the waterwheel 23 in exploded fashion. As will be appreciated from FIG. 2, the waterwheel 23 has a pair of spaced-apart wheel-shaped side plates 29, 31, each having an exterior surface (such as surface 33 in FIG. 2) and an interior surface (such as surface 35 in FIG. 2). The side plates 31, 33, are preferably formed of a rigid metal, such as ½ inch steel, although it is possible that a composite type material might be employed in some circumstances to reduce weight. Each of the side plates 31, 33, has a 3 inch diameter axle shaft 37 welded thereon at a generally right angle to the exterior surface 33 at a central location on each of the side plates. As best seen in FIG. 1, each of the axle shafts is rotatably mounted in a conventional bearing structure 39 located on the frame 13. This allows the waterwheel to be rotatable about a horizontal axis aligned with the axle shaft with respect to the stationary frame 13. In some cases, it may be desirable to reinforce the side plates 29, 31. In the embodiment of FIG. 2, the shaft 37 is welded to a smaller generally square plate 41 which, in turn, is welded to the exterior of the side plate 33. As can be seen in FIG. 2, the water receiving elements of the first version of the waterwheel preferably consist of a series of bucket shaped troughs 43, 45, 47, etc., made from e.g., 3/16 inch steel, which are welded between the two side plates 31, 33. This can be accomplished by laying one of the side plates down flat and placing the upright troughs in their proper position. They can then be welded in place. The opposing side plate can then be assembled and welded to the troughs. Each isolated trough appears as a flat pan having a bottom planar wall 49 and opposing side walls 51, 53. The height of the side walls 51, 53, may be different. For example, a prototype waterwheel was constructed which was 10 feet in diameter and 6 feet in width, weighing approximately 10,000 pounds. For the troughs on the prototype, a 6 foot wide sheet of metal was bent in a brake to have a front lip or edge 22 inches tall. The trough was formed with a 53 inch pan depth and with a 3 inch back lip or edge giving the trough a rectangular appearance. The troughs are set at a 45° angle with respect to each other. The holding capacity of the prototype waterwheel was about 2848 gallons with 70-80% of all the troughs being full at any given time during the rotation of the waterwheel The troughs are arranged in spiral-like fashion about the central axis 54 of the waterwheel which is co-incident with the axle shaft 37. In the version of the invention illustrated in FIG. 2, there are eight troughs welded between the two side plates 31, 33. Another version of the invention described later will have only five troughs.

As has been mentioned, the water driven systems of the invention are used to produce useful work. While many such systems might be utilized in the generation of electricity, there are many other useful applications, as well. For example, the previously mentioned use of such systems to operate belts and drive shafts to turn machinery.

It is envisioned that, to produce electricity in an economical fashion, the production version of the waterwheel 23 will be quite massive in design. For example, the waterwheel itself might be 20 feet in diameter (“d” in FIG. 2), meaning a radius of 10 feet (“r” in FIG. 2). This would be twice the size of the prototype which was constructed for test purposes. The troughs shown in FIG. 2 are, for example, 6 feet wide (“w₁” in FIG. 2), having a bottom planar wall which is 6 feet across (“w₂” in FIG. 2), and 2 feet deep (“h” in FIG. 2), providing a holding capacity of about 1200 cubic feet of water in each trough. It is also visualized that another version of the wheel might be 30 feet in diameter, for example.

Returning to FIG. 1, it can be seen that the system employs a water discharge manifold 55 associated with the frame enclosure 13. In the version of the invention illustrated in FIG. 1, the manifold is a pipe-like structure having a vertical extent 57 and a gently downwardly sloping horizontally inclined extent 59 which terminates in a discharge end 61 disposed above the waterwheel in discharge alignment with the water receiving elements 25, 27, etc.. The discharge end can be a plenum type structure, e.g., having a rectangular discharge opening positioned vertically over one side of the waterwheel.

A water collection reservoir 63 is disposed below the waterwheel 23 and integral with the frame 13 for the collection of water which has been discharged from the manifold 55 and received by the water receiving elements. As has been explained, imbalance resulting from filling the troughs causes the waterwheel to rotate axis of the axle shaft, with water being drained from the troughs at a low point in the rotation. In the case illustrated, the reservoir 63 is a horizontal tank having an inclined bottom wail 65. FIG. 1 is a simplified illustration, it being understood that the actual water collection reservoir might be elongated and the inclined wall 65 eliminated in some cases. The massive size of the waterwheel and its associated troughs create a type of mechanical advantage in the system which requires only a relatively small amount of electric power to power the water pump or pumps in the system. In some cases, it might be possible to use solar power, or the power available from a natural gas well at the site of the waterwheel to power the pump or pumps used in the system.

Water collected in the reservoir 63 is re-circulated in a continuous loop through the manifold 55 and back to the waterwheel by means of one or more water pumps. The pumps 67, 69, may be identical, but may advantageously be of two different types, for example, one being electric and the other being of the centrifugal or worm screw design. The pump design will not require high pressures, but rather will need a large pumping capacity, for example 6500 gallons/minute or 390,000 gallons/hour. The pumps may be driven by an associated external power source, such as any conveniently available source of natural gas, solar power, propane or other fossil fuels. It will be necessary from time to time to make up some losses of water in the system due to evaporation and the like. This can be accomplished by having a water holding tank nearby, or using municipal or other convenient sources.

For the prototype waterwheel, the output shaft of a 50 hp electric motor was connected through a belt drive to the drive shaft of a centrifugal pump having a 6500 gpm pumping capacity. The electric motor was electronically controlled with an Eaton® SVX9000 adjustable frequency drive controller (rheostat). The important factor here is the volume of water being supplied to the wheel and not the velocity of the water being pumped.

The rotational movement of the waterwheel and corresponding movement of the axle shafts 39 can be used to produce useful work, e.g., to drive an electrical generator for generating electrical power. It is possible that a conventional electrical generator might be mounted directly on the frame and be driven by the waterwheel to generate electrical power by one of the axle shafts of the waterwheel. However, in some versions of the invention, the frame 13 will also have mounted thereon a hydraulic pump 71, driven by the waterwheel axle shaft, which is used to drive a hydraulic motor 73, the hydraulic motor, in turn, being used to drive the electrical generator 75 for generating electrical power. The hydraulic motor and pump may also be incorporated in one commercially available unit. The hydraulic motor/pump and electrical generator might even sit beside the frame, or at another more distant location. In some cases, it may be desirable to have a gear/sprocket/pulley system, such as a gear box 77 located between a selected one of the axle shafts of the waterwheel and the hydraulic motor/pump for creating an increased rpm output for driving the hydraulic motor/pump.

As briefly mentioned, in some cases, it may be desirable to have a torque multiplier for the output shaft of the waterwheel to increase the rpm output. This might comprise a suitable gear, sprocket or pulley multiplier type system, such as a gear box located between a selected one of the axle shafts of the waterwheel arid the hydraulic pump/motor for creating an increased rpm output for driving the hydraulic pump/motor.

In the prototype system, the output shaft on one side of the waterwheel goes to a 50 inch, 4 belt sheave. The 50 inch sheave goes to an 8 inch sheave mounted onto the frame. An output shaft of the 8 inch sheave carries another 50 inch, 4 belt sheave which is mounted onto the frame. The belts of the 50 inch, 4 belt sheave drive another 8 inch sheave. The output shaft of this 8 inch sheave goes to a 26 inch sheave. The belts of the 26 inch sheave drive a 5½ inch sheave, mounted on the frame. The output shaft of the 5½ inch sheave goes to the drive shaft of the hydraulic motor/pump. This example pulley/sheave arrangement transforms the 10-12 rpm rotational speed of the waterwheel to approximately 1800 rpm's at the hydraulic motor/pump drive shaft. The hydraulic motor/pump can be used to drive an electric generator in conventional fashion. The principal objective is to design a system of the type described which would drive a generator sufficient to be economically feasible; for example, to drive a 200-300 Kwatt generator of the type currently driven by wind powered sources, and the like.

The system could also be simplified, as by going from a sprocket on the main shaft to a transmission, using a chain as described. This would eliminate the pulleys and belts.

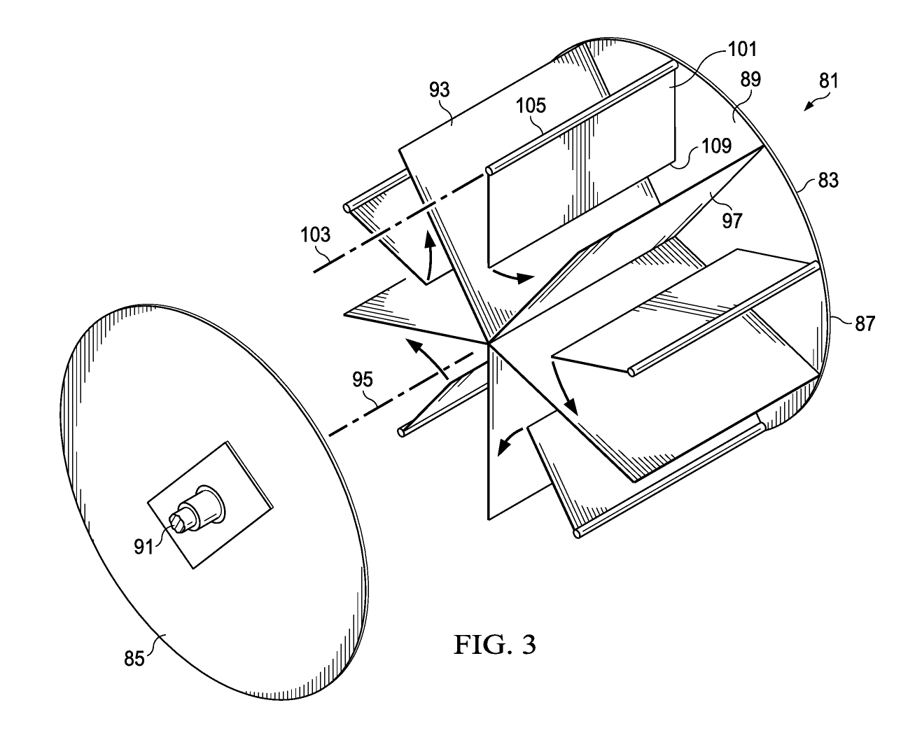

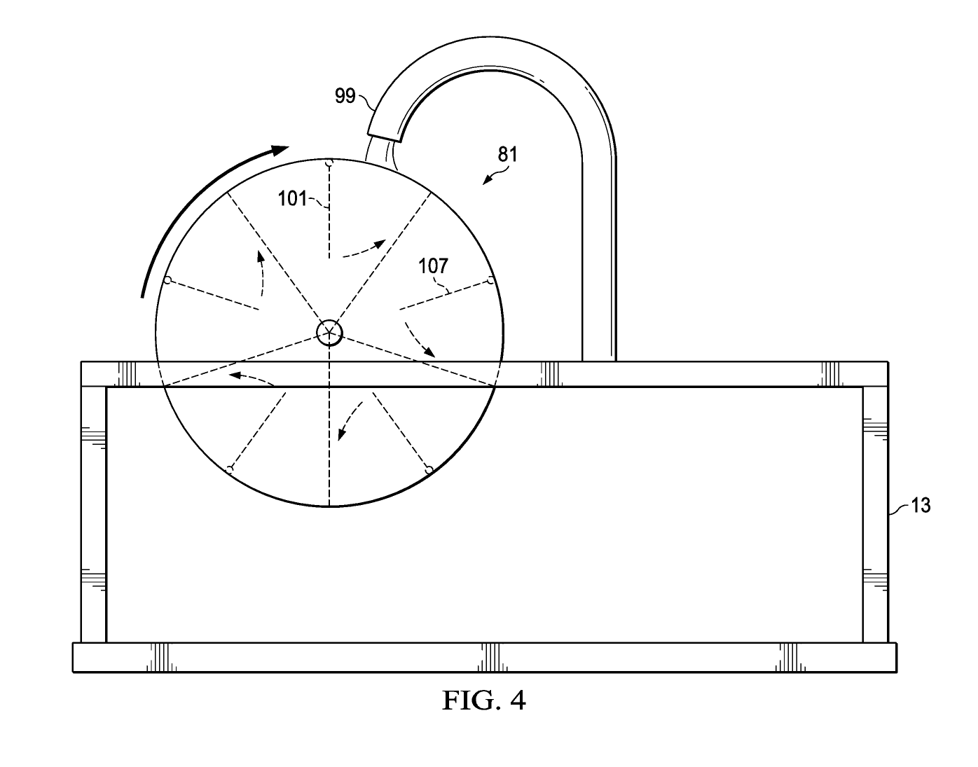

FIGS. 3 and 4 illustrate, in simplified fashion, another version of the waterwheel of the invention. The improved waterwheel 81 shown in FIGS. 3 and 4 again has a pair of spaced apart wheel shaped side plates 83, 85, each having an exterior surface 87 and an interior surface 89. Each of the side plates 83, 85 has an axle shaft 91 welded thereon at a right angle to the exterior surface at a central location on each of the side plates. The axle shafts are each being mounted in a bearing structure on the frame for rotational movement with respect to the frame.

Unlike the first version of the waterwheel shown in FIGS. 1 and 2, the improved waterwheel shown in FIGS. 3 and 4 has water receiving elements which are comprised of a series of flat metal sheets (such as sheet 93 in FIG. 3) which radiate outwardly from a central axis 95 of the waterwheel and which are welded between the two side plates 83, 85. As will be appreciated from FIG. 3, each pair of adjacent metal sheets (such as sheets 93, 97) define a V-shaped trough for receiving water from the water discharge manifold (99 in FIG. 4). Although the number could Vary, there are five of the flat metal sheets 97 in the version of the invention shown in FIGS. 3 and 4 which radiate outwardly from the central axis of the waterwheel and which are welded between the two side plates, the flat metal sheets forming a star-shaped pattern with respect to the central axis. In this case, the flat metal sheets are located at angle of 360°, 288°, 216°, 144° and 72° with respect to each other.

The water receiving elements of the improved waterwheel shown in FIG. 3 further include a flat metal pivot sheet (such as sheet 101 in FIG. 3) mounted on a pivot axis 103 defined by a pivot rod 105 which is welded between the side plates 83, 85, at a right angle thereto. Each of the pivot rods which is used to support the flat metal pivot sheets spans an interior space of the waterwheel between two points located adjacent an outer periphery of each of the side plates. As will be appreciated from the dotted lines in FIG. 4, the flat metal pivot sheets 101 are moved from an initially open position (shown by the dotted line 101 in FIG. 4) to a closed position (illustrated by the arrow and dotted line 107 in FIG. 4) as water being discharged from the water discharge manifold is discharged downwardly into a respective V-shaped trough.

In other words, as shown in FIG. 4, water from the water discharge manifold 99 enters a respective V-shaped trough which has moved into position below the discharge manifold. Water begins to fill the trough. As the trough fills and the waterwheel continues to turn in a clockwise direction, as viewed in FIG. 4, the associated flat metal pivot sheet 101 moves from the initially open (vertical) position to the closed position (illustrated by the movement of the dotted line as water begins to gradually fill then associated V-shaped trough. Movement of the respective flat metal pivot sheet 101 to the closed position results in the pivot sheet forming a water retaining wall within an interior space defined between the associated flat metal sheets which make up the V-shaped trough. Although an absolute water tight seal is not required, the bottom edge (109 in FIG. 3) could be provided with a rubber lip, or the like, to facilitate retaining the water in the respective trough.

Continued movement of the waterwheel about the central axis causes the respective flat metal pivot sheet to move from the closed position to the open position as water is discharged from the V-shaped trough into the water collection reservoir. The gradual filling of the respective V-shaped trough causes the waterwheel to rotate about the central axis 95 so that a second respective v-shaped trough is brought into position below the water discharge manifold 99.

It will be appreciated from FIG. 4 that the discharge point of the water discharge manifold 99 has been moved from the side, peripheral location shown in FIG. 1 to the generally overhead, more centrally located position of FIG. 4. The outer extent of the water discharge manifold 99 is also moved a few inches away from the walls of the waterwheel (relative to the position shown in FIG. 1).

### The Pontoon or Barge Mounted Version of the Invention

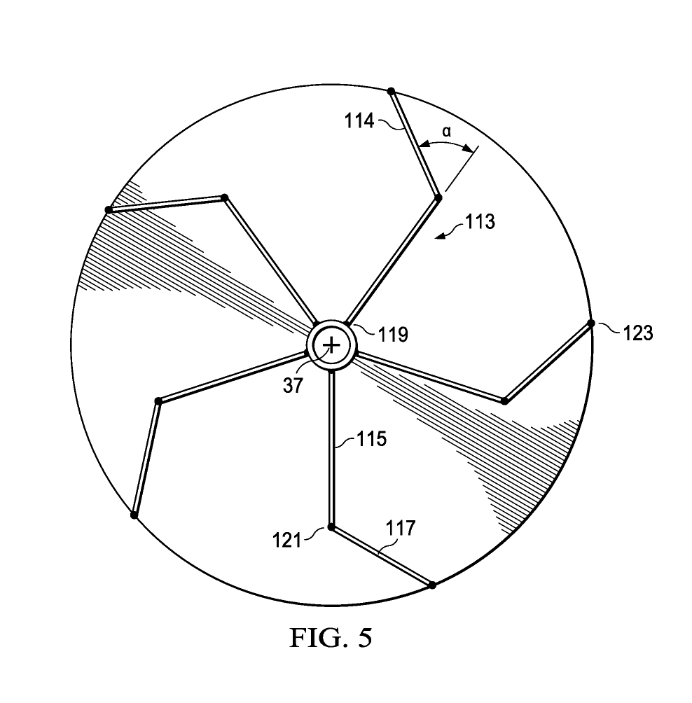

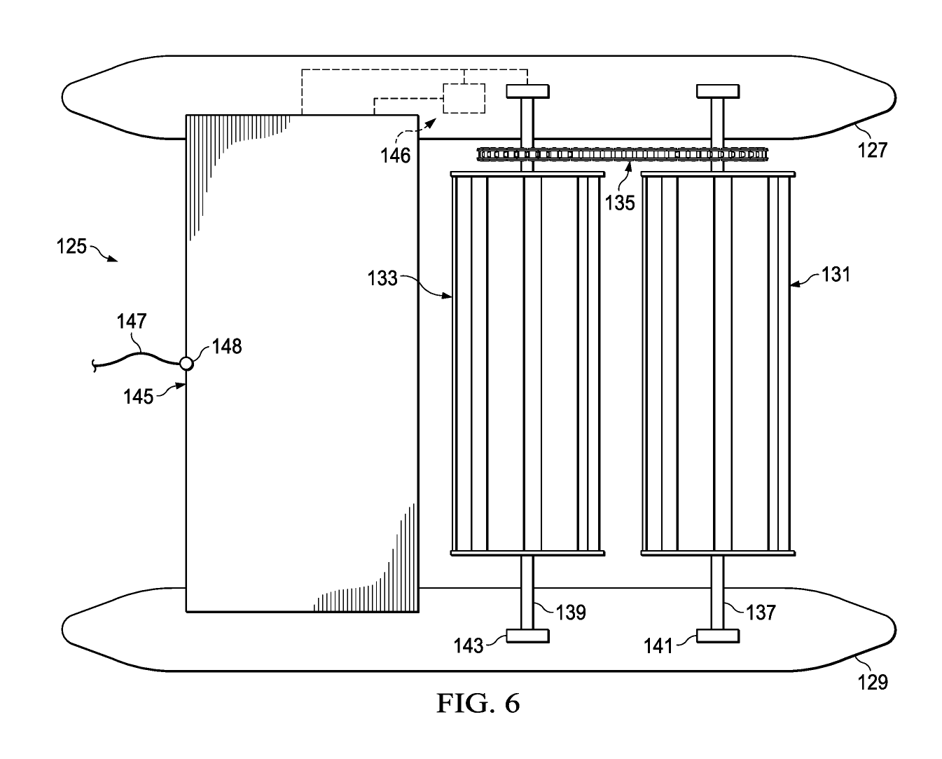

FIGS. 5 and 6 together illustrate another version of the water driven system of the invention. Unlike the self-contained system described in FIGS. 1 -4, the system shown in FIGS. 5 and 6 is intended to be mounted on a floating support structure. This floating support structure can assume various forms. In the embodiment shown in FIG. 6, the floating support structure is a pontoon, designated generally as 125. The pontoon 125 has a pair of spaced apart frame portions, such as the outriggers 127, 129. The floating support structure could also be, for example, a barge-like structure.

In the version of the waterwheel shown in FIG. 5, mere are no troughs as were present in the version of the waterwheel shown in FIG. 1. In this case, there are a series of spokes, each having an inner extent 115 and an outer extent 117. The outer extents are bent at an angle in the range from about 45 to 75°, preferably from about 55 to 65°, most preferably about 60°, from the plane of the inner extent thereof. In other words, the outer extent 114 in FIG. 5 is bent at an angle “α” which in this case happens to be approximately 60°. The spokes can conveniently be formed by welding a longer piece of metal 115 and a relatively shorter piece of metal 117 along their entire lengths, as shown in FIG. 5. The longer piece 115 is approximately two thirds of the total length of the spoke, with the angled, shorter piece 117 making up the remaining approximate one third portion of the overall length. The inner, longer pieces of the spokes form a star shaped pattern approximately 72° apart about the axis of the central shaft 37. In tills version of the waterwheel of the invention, there are five spokes. The particular arrangement and shape of the spokes shown in FIG. 5 help to eliminate any tendency of the waterwheel to move in a backward direction in operation. At least one waterwheel, as previously described with respect to FIG. 5, is mounted between the two spaced apart frame portions in the upright manner shown in FIG. 6. FIG. 6 shows one form of the system of the invention in which a pair of watersheds 131, 133 are mounted on the pontoon 125. The two watersheds shown in FIG. 6 are coupled together, in this case by a chain and sprocket arrangement 135. Each of the watersheds has a plurality of spokes for turning the waterwheel in response to a flow of water against the spokes when the floating support structure is mounted on a moving body of water.

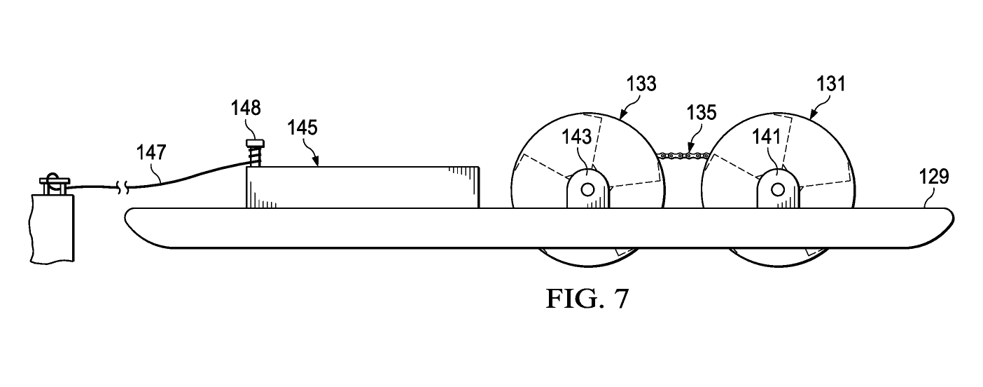

The axle shafts of each of the watersheds (137, 139 in FIG. 6) are each mounted between the pair of spaced apart pontoons 127, 129 in a suitable bearing structure 141, 143, for rotational movement with respect to the frame portions. As has previously been described in detail, the rotational movement of the axle shafts is used to produce useful work. FIGS. 6 and 7 show the work produced by the rotation of the axles 137, 139 being converted to electrical energy in a suitable conversion unit (shown in simplified fashion as 145). The conversion unit may take various forms. For example, the rotational movement of the axles 131, 133 may be used to power a hydraulic pump, driven by the waterwheel axle shaft, which is used to drive a hydraulic motor, the hydraulic motor, in turn, being used to drive the electrical generator for generating electrical power, as has previously been described with respect to FIGS. 1-4. The hydraulic pump and motor may be combined in one unit. The hydraulic motor/pump and electrical generator might even sit beside the pontoon on a river or stream bank in some suitable locations. A transmission system is shown in simplified, schematic fashion as 146 in FIG. 6. In some cases, it may be desirable to have a torque multiplier for the output shafts of the watersheds to increase the rpm output, as has also been previously described. This might comprise a suitable gear, sprocket or pulley multiplier type system, such as a gear box located between a selected one of the axle shafts of the waterwheel and the hydraulic pump/motor for creating an increased rpm output for driving the hydraulic pump/motor.

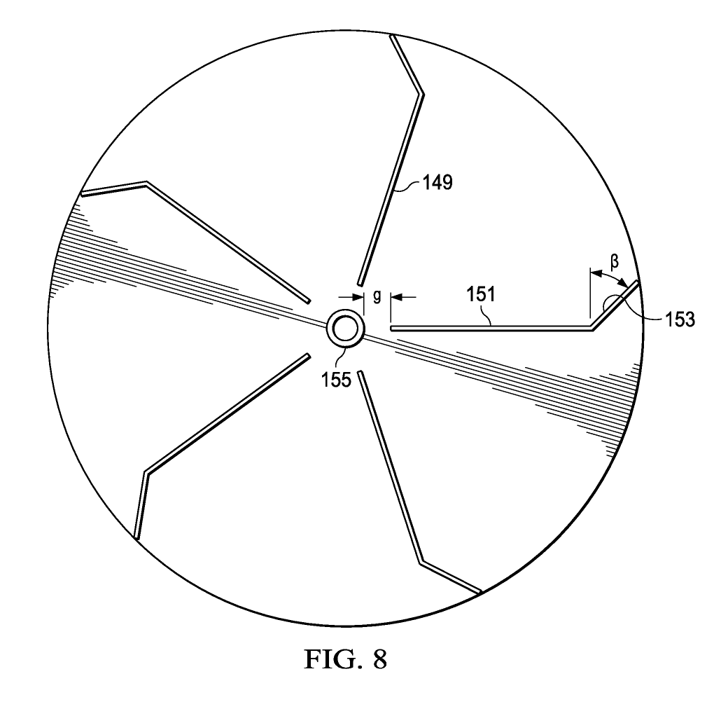

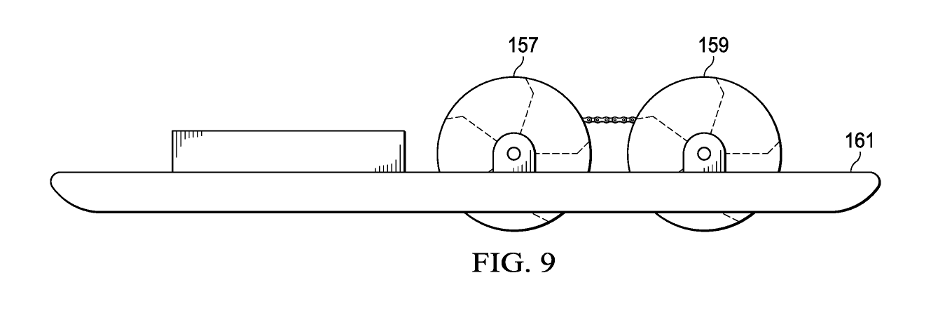

The pontoon shown in FIGS. 6 and 7 will typically be tethered to the adjacent stream or river bank by a line or cable, for example attached to the front of the floating support structure. This is illustrated in simplified fashion by the tether 147 in FIGS. 6 and 7 which is secured at one end to the tie point 148. The opposite end of the tether 147 would be secured to a tie down point on the bank adjacent the moving body of water. The tie down point of the tethering cable on the stream or river bank can be varied or adjusted to adjust the angle at which the pontoon sits with respect to the flowing body of water. By controlling the relative angle of the pontoon in the water, the turning of the waterwheel, as well as the generation of electric power, may be controlled. FIGS. 8 and 9 show a final evolution of the preferred waterwheel for use with a pontoon system of the type previously described. While the waterwheel shown in these figures is similar in some respects to the waterwheel of FIG. 5, it also differs in some significant respects which are critical to the most efficient operation of the waterwheel.

It will be apparent from FIG. 8 that the spokes 149 are again bent with a relatively longer inner extent 151 and a relatively shorter outer extend 153. The inner extent 151 again makes up about two thirds of the overall length of the spoke. In this case, however, the spokes 149 do not run all the way to the central shaft 155, but are separated by a “gap” illustrated as “g” in FIG. 8. The spokes are welded solid, i.e., along their entire lengths, between the side plates of the waterwheel. The size of the gap is not particularly critical to the operation of the waterwheel, but lowers the overall weight. It could be, for example, about one eighth to about one fourth the length of the inner extent 151.

The spokes are also bent at a more “relaxed” angle in the version of the waterwheel shown in FIG. 8. For example, the angle “β” shown in FIG. 8 can be in the range from about 35 to 65°, with respect to a line drawn perpendicular to the plane of the inner extent. The preferred angle will typically be in the range from about 40 to 50°, most preferably about 45°. Again, the inner, longer extents of the spokes form a star shaped pattern of approximately 72° apart with respect to the axis of the central shaft 155. As has been mentioned, there are no “buckets” or “troughs” in this version of the invention, since the spokes are only used to contract the moving stream of water to turn the waterwheel. As a result, the more relaxed angle of the outer extents more efficiently works for this intended purpose. The waterwheel can also be constructed of a lighter weight material than the previously described land based version of the waterwheel.

In one exemplary version of the device, the side plates are 4 feet in diameter and have a 2 inch central opening for a 2 inch by 6 foot solid shaft. The side plates can be, for example, ⅜ inch plate. Each spoke can be, for example, 2 feet by 4 feet.

FIG. 9 shows a pair of waterwheels of the improved design, 157, 159, mounted on a pontoon boat 161.

While one preferred form of the invention uses the useful work produced by the system to generate electricity, the system is not thus limited. There are many applications in which the rotational movement of the axles of the waterwheels can be harnessed and used as a water powered motor, for example.

An invention has been shown with several advantages. The water driven system of the invention uses water as the motive force for creating useful work. One application of the work produced by the system is to generate electricity, rather than using polluting fuels such as burning fossil fuels. The water in the first version of the system is re-circulated in a continuous loop so mat only losses for evaporation need to be made up. It is not accessary that the system be located near a river or other body of water, because the design of the system is self-sufficient.

In the second version of the system of the invention, the work generating system is mounted on a floating support structure, such as a barge or pontoon which is located on a flowing body of water. It is not necessary to supplement the water supply to this version of the system, since the system is harnessing the energy of the flowing body of water passing beneath the pontoon. This system is extremely simple in design and economical to manufacture. The design of the waterwheel used in this version of the water driven system is particularly efficient in converting the energy of the moving water to useful work.

This system of the invention thus provides a relatively inexpensive power generating system that can easily be set up on a bank of a stream or river and is operable to generate electric power or other forms of useful work as a water powered motor and the like.

While the invention has been shown in several of its forms, it is not thus limited but is susceptible to various changes and modifications without departing from the spirit thereof as described in the claims which follow.

What is claimed is:

1. A water driven system for producing useful work, the system comprising:
a floating support structure having a pair of spaced apart frame portions;
at least one waterwheel mounted between the two spaced apart frame portions, the waterwheel being mounted in an upright manner and having a plurality of spokes for turning the waterwheel in response to a flow of water against the spokes when the floating support structure is mounted on a moving body of water;
wherein the waterwheel has a pair of spaced apart wheel shaped side plates each having an exterior surface and an interior surface, and wherein each of the side plates has an axle shaft welded thereon at a right angle to the exterior surface at a central location on each of the side plates, the axle shafts each being mounted between the pair of spaced apart frame portions for rotational movement with respect to the frame portions;
wherein the rotational movement of the axle shafts is used to produce useful work;
wherein the spokes of the waterwheel are comprised of a series of bent metal sheets which radiate outwardly from a central axis of the waterwheel and which are welded between the two side plates, each bent metal sheet having a longer inner extent and a shorter outer extent which is bent at an angle in the range from 40 to 50° with respect to a line drawn perpendicular to the plane of the inner extent;
wherein each of the spokes is formed by welding a longer piece of metal and a shorter piece of metal along their entire lengths to the respective side plates of the waterwheel in the bent shape previously described; and
wherein the longer piece of metal makes up two thirds of the length of each spoke, the shorter piece making up the remaining one third portion of the overall length of the spoke.

2. A water driven system for producing useful work, the system comprising:
a pontoon having a pair of spaced apart and interconnected outriggers;
at least one waterwheel mounted between the two spaced apart outriggers, the waterwheel being mounted in an upright manner and having a plurality of spokes for turning the waterwheel in response to a flow of water against the spokes;
wherein the waterwheel has a pair of spaced apart wheel shaped side plates each having an exterior surface and an interior surface, and wherein each of the side plates has an axle shaft welded thereon at a right angle to the exterior surface at a central location on each of the side plates, the axle shafts each being mounted between the pair of spaced apart outriggers of the pontoon for rotational movement with respect to the pontoon;
wherein the rotational movement of the axle shafts is used to produce useful work;
wherein the spokes of the waterwheel are comprised of a series of bent metal sheets which radiate outwardly from a central axis of the waterwheel and which are welded between the two side plates, each bent metal sheet having a longer inner extent and a shorter outer extent which is bent at an angle in the range from 40 to 50° with respect to a line drawn perpendicular to the plane of the inner extent;
wherein each of the spokes is formed by welding a longer piece of metal and a shorter piece of metal along their entire lengths to the respective side plates of the waterwheel in the bent shape previously described;
wherein the longer piece of metal makes up two thirds of the length of each spoke, the shorter piece making up the remaining one third portion of the overall length of the spoke;
wherein there are five spokes formed between the side plates of the waterwheel; and
wherein the inner, longer pieces of the spokes each has an innermost extent, the innermost extent of each spoke being spaced-apart from the axle shaft of the waterwheel by a gap.

3. The water driven system of claim 2, wherein the size of the gap is between one eighth to one fourth the length of the inner extent of each spoke.

4. The water driven system of claim 2 wherein the inner, longer pieces of the spokes form a star shaped pattern 72° apart about the axis of the central shaft.

5. The water driven system of claim 2, characterized by the absence of buckets or troughs for catching and retaining water as current flows beneath the pontoon.

6. The water driven system of claim 2, wherein the angle of the shorter outer extent of each spoke forms an angle of 45° relative to the inner extent.

7. A method of producing useful work using a water driven system, the method comprising the steps of:
providing a pontoon having a pair of spaced apart and interconnected outriggers;
providing at least one waterwheel mounted between the two spaced apart outriggers, the waterwheel being mounted in an upright manner and having a plurality of spokes for turning the waterwheel in response to a flow of water against the spokes;
wherein the waterwheel has a pair of spaced apart wheel shaped side plates each having an exterior surface and an interior surface, and wherein each of the side plates has an axle shaft welded thereon at a right angle to the exterior surface at a central location on each of the side plates, the axle shafts each being mounted between the pair of spaced apart outriggers of the pontoon for rotational movement with respect to the pontoon;
wherein the rotational movement of the axle shafts is used to produce useful work;
wherein the spokes of the waterwheel are comprised of a series of bent metal sheets which radiate outwardly from a central axis of the waterwheel and which are welded between the two side plates, each bent metal sheet having a longer inner extent and a shorter outer extent which is bent at an angle in the range from 40 to 50° with respect to a line drawn perpendicular to the plane of the inner extent;
wherein each of the spokes is formed by welding a longer piece of metal and a shorter piece of metal along their entire lengths to the respective side plates of the waterwheel in the bent shape previously described;
wherein the longer piece of metal makes up two thirds of the length of each spoke, the shorter piece making up the remaining one third portion of the overall length of the spoke;
wherein the inner, longer pieces of the spokes each has an innermost extent, the innermost extent of each spoke being spaced-apart from the axle shaft of the waterwheel by a gap;
wherein the pontoon is tethered to an adjacent stream or river bank by a tether, the tether being secured at one end to a tie down point on the pontoon and at an opposite end to a tie down point on the bank, whereby the length of the tether can be varied to adjust an angle at which the pontoon sits with respect to the flowing body of water, controlling the angle of the pontoon serving to control the speed of the turning of the waterwheel.

8. The method of claim 7, wherein the size of the gap is between one eighth to one fourth the length of the inner extent of each spoke.

9. The method of claim 7 wherein the inner, longer pieces of the spokes form a star shaped pattern 72° apart about the axis of the central shaft.

10. The method of claim 2, characterized by the absence of buckets or troughs for catching and retaining water as current flows beneath the pontoon.

11. The method of claim 2, wherein the angle of the shorter outer extent of each spoke forms an angle of 45° relative to the inner extent.

12. The method of claim 2, wherein the inner, longer pieces of the bottom walls form a star shaped pattern 72° apart about the axis of the central shaft.
